(19) United States
(12) Patent Application Publication
(10) Pub. No.: US 2026/0229709 A1
(43) Pub. Date: Aug. 6, 2026

(54) SECONDARY BATTERY AND METHOD OF MANUFACTURING SECONDARY BATTERY

(71) Applicant: SAMSUNG SDI CO., LTD., Yongin-si (KR)

(72) Inventor: Jaeil SEONG, Yongin-si (KR)

(21) Appl. No.: 19/408,548

(22) Filed: Dec. 4, 2025

(30) Foreign Application Priority Data
Feb. 3, 2025 (KR) 10-2025-0012943

(51) Int. Cl. H01M 50/474; H01M 10/04; H01M 50/103; H01M 50/119; H01M 50/15; H01M 50/159; H01M 50/477; H01M 50/486

(52) U.S. Cl. CPC H01M 50/474; H01M 10/049; H01M 50/103; H01M 50/119; H01M 50/15; H01M 50/159; H01M 50/477; H01M 50/486

(57) ABSTRACT

A secondary battery includes a case in which an opening is formed. An electrode assembly is accommodated in the case, with the electrode assembly including an electrode. An electrode tab is connected to the electrode and protrudes outwardly from the electrode assembly, a cover covers the opening in the case to seal the electrode assembly from outside. An insulating member is placed on a surface of the electrode tab coupled to the side of the case, with the insulating member being positioned between the electrode assembly and the electrode tab.

### CROSS-REFERENCE TO RELATED APPLICATION

This application claims priority under 35 U.S.C. § 119 to Korean Patent Application No. 10-2025-0012943, filed in the Korean Intellectual Property Office on Feb. 3, 2025, the entire contents of which are hereby incorporated by reference.

### BACKGROUND

### Field

The present disclosure relates to a secondary battery and a method of manufacturing the secondary battery.

### Description of Related Art

Unlike primary batteries that are not designed to be recharged, secondary (or rechargeable) batteries are batteries that are designed to be discharged and recharged. Low-capacity secondary batteries are used in portable, small electronic devices, such as smart phones, feature phones, notebook computers, digital cameras, and camcorders. Large-capacity secondary batteries are widely used as power sources for driving motors in hybrid vehicles and electric vehicles and for storing power (e.g., home and/or utility scale power storage). A secondary battery generally includes an electrode assembly that includes a positive electrode and a negative electrode, a case accommodating the electrode assembly, and electrode terminals connected to the electrode assembly.

With the recent demand for lighter secondary batteries in portable IT devices, automobiles, and vehicles, there has been active research into small and slim batteries. To achieve miniaturization and slimness of battery, a conventional method is directed to increasing energy density by reducing the thickness of materials such as a substrate, a separator, a casting material, etc., or improving the physical properties of active materials. However, such a conventional method may make secondary batteries less safe.

Another method of increasing energy density is to minimize dead volume inside secondary batteries. For example, techniques have been researched to increase the energy density of secondary batteries by reducing the internal areas that do not contribute to the capacity of secondary batteries.

Generally, an electrode tab of an electrode assembly is connected to an electrode terminal in the case, and the electrode assembly is accommodated within the case. An insulating case is provided inside the case to prevent short-circuits between the electrode tab and the case. However, the space for accommodating the insulating case may form dead volume of the secondary battery.

The information disclosed in this section is for the enhancement of understanding of the background of the present disclosure. It may contain information that does not constitute related or prior art.

### SUMMARY

The present disclosure is aimed at providing a secondary battery and a method of manufacturing the secondary battery for solving the above-described problems.

However, the technical problems to be solved by the present disclosure is not limited to the above-described problems, and other problems not mentioned herein, and aspects and features of the present disclosure that would address such problems, will be clearly understood by those skilled in the art from the description of the present disclosure below.

Aspects of embodiments provide a secondary battery including a case in which an opening is formed, an electrode assembly accommodated in the case, with the electrode assembly including an electrode, an electrode tab connected to the electrode and protruding outwardly from the electrode assembly, the electrode tab being coupled to a side of the case, a cover covering the opening the case and sealing the electrode assembly from outside of the case, and an insulating member placed on a surface of the electrode tab coupled to one side of the case, the insulating member being positioned between the electrode assembly and the electrode tab.

According to one embodiment, the electrode tab may include a first end portion coupled to the side of the case, and a second end portion extending from the first end portion to the electrode assembly, and the second end portion being bent at least once inside the case.

According to one embodiment, the insulating member may include a first insulating member disposed on a surface of the first end portion, and a second insulating member between a surface of the second end portion adjacent to the electrode assembly and the electrode assembly.

According to one embodiment, the insulating member may include an adhesive layer coupled to a surface of the electrode tab, and an insulating layer provided on a surface of the adhesive layer.

According to one embodiment, the insulating layer may include at least one of polyethylene terephthalate (PET), polypropylene (PP), and polyether ether ketone (PEEK).

According to one embodiment, the adhesive layer may have a thickness of 20 μm to 40 μm greater than a thickness of the electrode tab.

According to one embodiment, the insulating layer may have a thickness of 180% to 220% of a thickness of the adhesive layer.

According to one embodiment, the case and the cover may be formed of a same metal material.

According to one embodiment, the metal material may include stainless use steel.

According to one embodiment, a thickness of the case or the cover may be 50 μm to 100 μm.

According to one embodiment, the electrode may include a first electrode and a second electrode, wherein the electrode tab includes a first electrode tab connected to the first electrode, and a second electrode tab connected to the second electrode, the second electrode tab being spaced apart from the first electrode tab and protruding from a surface of the electrode assembly, wherein the insulating member extends in a width direction of the case to cover at least part of the first electrode tab and at least a part of the second electrode tab.

According to one embodiment, the electrode assembly may be accommodated in the case such that an inner side of the case and an upper surface of the electrode assembly to face each other, with the insulating member being disposed between the inner side of the case and the upper surface of the electrode assembly.

Aspects of embodiments provide a method of manufacturing a secondary battery including forming an electrode assembly with an electrode tab connected to an electrode and protruding outwardly, preparing a case with an opening, attaching the electrode tab to a side of the case, arranging an insulating member on the electrode tab coupled to the side of the case and on the electrode tab adjacent to the electrode assembly, bending the electrode tab at least once, inserting the electrode assembly into the case, and attaching a cover to the opening in the case to seal the electrode assembly from outside.

According to one embodiment, the electrode tab may include a first end portion attached to the side of the case, and a second end portion extending from the first end portion to the electrode assembly and bent at least one to be accommodated inside the case.

According to one embodiment, the arranging of the insulating member may include arranging a first insulating member on a surface of the first end portion, and arranging a second insulating member on a surface of the second end portion adjacent to the electrode assembly.

According to one embodiment, the attaching of the electrode tab may include welding the first end portion to an inner side of the case.

According to one embodiment, the insulating member may include an adhesive layer attached to a surface of the electrode tab, and an insulating layer provided on a surface of the adhesive layer.

According to one embodiment, the arranging of the insulating member may include attaching the adhesive layer to the electrode tab coupled to the side of the case.

According to one embodiment, the insulating layer may include at least one of polyethylene terephthalate (PET), polypropylene (PP), and polyether ether ketone (PEEK).

According to one embodiment, the inserting of the electrode assembly may include, in response to the bent electrode tab and the insulating member being disposed between an inner side of the case and an upper side of the electrode assembly, arranging the electrode assembly to with the inner side of the case and the upper side of the electrode assembly facing each other.

According to embodiments of the present disclosure, short-circuits may be prevented between an electrode assembly and an electrode tab and between an electrode tab and a case by arranging an insulating member between a surface of the electrode tab coupled to the case and between the electrode tab and the electrode assembly. Dead volume inside the case may thereby be reduced and the energy density of a secondary battery may be increased.

According to embodiments of the present disclosure, a space required for accommodating an insulating case for preventing short-circuits between a case, a cover, and an electrode assembly of a secondary battery may be removed, thereby ensuring a larger electrode accommodating space in the case.

According to embodiments of the present disclosure, an insulating member may include an adhesive layer to stably fix an electrode tab coupled to a case. In some embodiments, the insulating member may be disposed between the bent electrode tab and the electrode assembly such that the electrode tab may stably maintain its bent state.

According to embodiments of the present disclosure, the insulating member may have a thickness greater than that of the electrode tab and fill a space between the electrode tab and the electrode assembly in the length direction of the case. With this configuration, movement of the electrode assembly may be prevented in the length direction of the case. Thus, deformation due to the movement of the electrode assembly by dropping, etc., may be prevented, ignition accidents caused by the occurrence of short-circuits may be prevented, and the secondary battery is made safer.

However, aspects and features of the present disclosure are not limited to those described above, and other aspects and features not mentioned will be clearly understood by a person skilled in the art from the detailed description described below.

### BRIEF DESCRIPTION OF DRAWINGS

The drawings illustrate embodiments of the present disclosure, and further describe aspects and features of the present disclosure together with the detailed description of the present disclosure. The present disclosure should not be construed as being limited to the embodiments depicted in the drawings.

FIG. 1 is an exploded perspective view of a secondary battery according to embodiments of the present disclosure;

FIG. 2 is a perspective view of a secondary battery according to embodiments of the present disclosure;

FIG. 3 is a cross-sectional view of a secondary battery according to a comparative example;

FIG. 4 is a cross-sectional view taken along line A-A′ of FIG. 2;

FIG. 5 is a view of a state where an electrode tab of a secondary battery is coupled to one side of a case according to embodiments of the present disclosure;

FIG. 6 is a view of a state where an insulating member is added to a first end portion of FIG. 5;

FIG. 7 is a view of a state where an insulating member is added to a second end portion of FIG. 6;

FIG. 8 is a view of a state where an electrode assembly in FIG. 7 is accommodated inside a case;

FIG. 9 is a view showing a cover is coupled to a case of FIG. 8;

FIG. 10 is a cross-sectional view taken along line B-B′ of FIG. 8;

FIG. 11 is an enlarged view of area A of FIG. 10; and

FIG. 12 is a flowchart of a method of manufacturing a secondary battery according to embodiments of the present disclosure.

### DETAILED DESCRIPTION

Hereinafter, embodiments of the present disclosure will be described in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to be limiting of the present disclosure.

In this specification, singular expressions include plural expressions unless the context clearly specifies singular expressions. In addition, plural expressions include singular expressions unless the context clearly specifies plural expressions. Throughout the specification, when a part is described as including a component, it implies that additional components may also be included unless specifically stated to the contrary.

According to embodiments of the present disclosure, the sizes of layers and areas are illustrated in the drawings may be exaggerated for clarity of explanation. The sizes in the drawings are only for ease of explanation, but the present disclosure is not limited thereto. Like reference numerals in the drawings denote like elements throughout the specification.

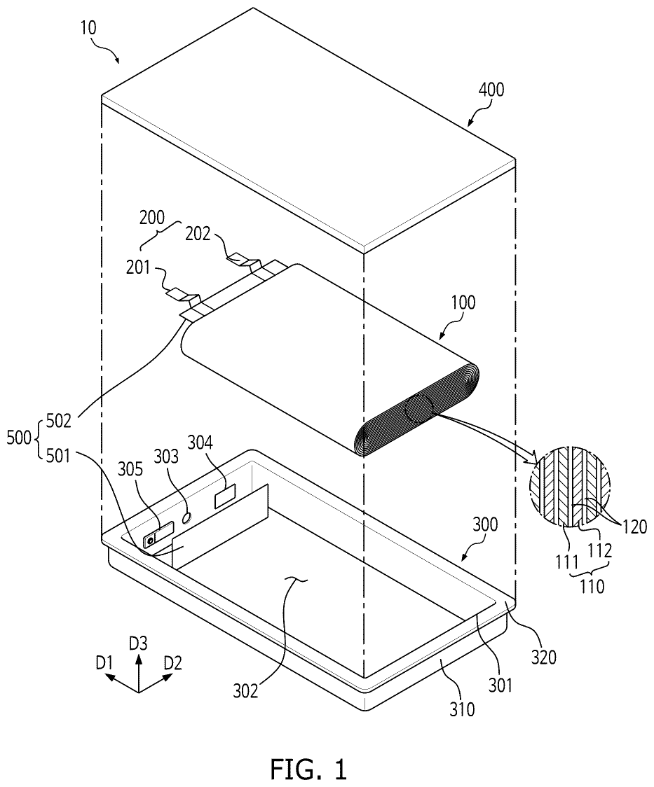

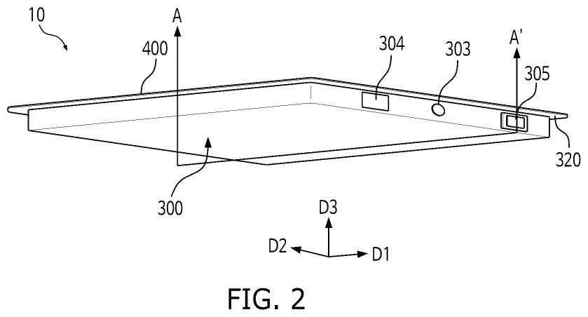

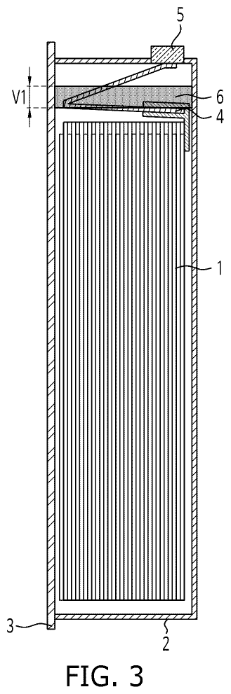

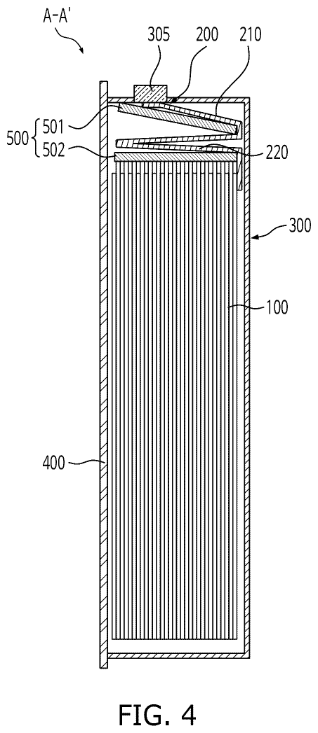

FIG. 1 is an exploded perspective view of a secondary battery according to embodiments of the present disclosure, FIG. 2 is a perspective view of a secondary battery according to embodiments of the present disclosure, and FIG. 3 is a cross-sectional view of a secondary battery according to a comparative embodiment, and FIG. 4 is a cross-sectional view taken along line A-A′ of FIG. 2.

Referring to FIG. 1, FIG. 2, and FIG. 4, a secondary battery 10 may include an electrode assembly 100, an electrode tab 200 protruding outwardly from the electrode assembly 100, a case 300 configured to accommodate the electrode assembly 100, a cover 400 coupled to the case, and an insulating member 500. The insulating member 500 may be formed of an insulating material such as polymers, resins, and rubber, etc., which are high molecular compounds that do not conduct electricity. The insulating member 500 may be disposed on a surface of the electrode tab 200 coupled to a side of the case 300, and the insulating member 500 may be disposed between the electrode assembly 100 and the electrode tab 200, which is bent. The insulating member 500 may be placed at the area that needs to insulate between the electrode assembly 100, the case 300, and/or the electrode tab 200 to prevent short-circuits of the secondary battery 10 when the electrode assembly 100 is accommodated in the case 300.

The electrode assembly 100 may include an electrode 110. The electrode 110 may include a first electrode 111 and a second electrode 112. The electrode assembly 100 may be formed by winding or stacking a stacked body of the first electrode 111, the separator 120, and the second electrode 112, which are formed from thin plates or thin films.

When the electrode assembly 100 is a wound stacked body, a winding axis may be parallel to the vertical-axis direction of the case 300. In another example, the electrode assembly 100 may be a stack-type rather than a winding-type. However, the shape of the electrode assembly 100 is not limited in the present disclosure.

According to further embodiments, the electrode assembly 100 may be a z-stack electrode assembly 100 where a positive electrode plate and a negative electrode plate are inserted to sides of the separator 120, which is then bent into a z-shape. One or more electrode assemblies 100 may be stacked to allow the longitudinal sides thereof to be adjacent to one another to be accommodated inside the case 300, and the number of electrode assemblies 100 is not limited in the present disclosure. The first electrode 111 of the electrode assembly 100 may function as a negative electrode, and the second electrode 112 may function as a positive electrode. In other embodiments, the first electrode 111 of the electrode assembly 100 may function as a positive electrode, and the second electrode 112 may function as a negative electrode.

The electrode tab 200 may be connected to the electrode 110 and extend outwardly from the electrode assembly 100. The electrode tab 200 may include a first electrode tab 201 and a second electrode tab 202.

The first electrode 111 may be formed by applying an active material such as graphite or carbon to a current collector formed from a metal foil such as copper, copper alloy, nickel or nickel alloy. The first electrode 111 may include a first non-coated part where an active material is not provided. The first non-coated part may be connected to the first electrode tab 201 that is separately formed, or a portion of the first non-coated part may be stamped to form the first electrode tab 201.

The second electrode 112 may be formed by applying an active material such as a transition metal oxide, to a current collector formed of a metal foil such as aluminum or an aluminum alloy. The second electrode 112 may include a second non-coated part where an active material is not provided. The second non-coated part may be connected to the second electrode tab 202 that is separately formed, or a portion of the non-coated part may be stamped to form the second electrode tab 202.

Referring to FIG. 1, the first electrode tab 201 and the second electrode tab 202 protrude in the same direction, but in other embodiments the first electrode tab 201 and the second electrode tab 202 may be formed to protrude in different directions. The structure of the electrode assembly 100 described above and depicted in FIG. 1 is only exemplary, and the present disclosure is not limited thereto.

The first electrode 111 may function as a positive electrode, in which case the first substrate may be a positive electrode substrate. The positive electrode substrate may be formed of aluminum foil, and the positive electrode active material may include, for example, a transition metal oxide.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide include lithium nickel-based oxide, lithium cobalt-based oxide, lithium manganese-based oxide, lithium iron phosphate-based compound, cobalt-free nickel-manganese-based oxide, or a combination thereof. As examples, the following compounds represented by any one of the following Chemical Formulas may be used: LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α}(0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8). In these Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be, for example, a high nickel-based positive electrode active material having a nickel amount of greater than or equal to about 80 mol %, greater than or equal to about 85 mol %, greater than or equal to about 90 mol %, greater than or equal to about 91 mol %, or greater than or equal to about 94 mol % and less than or equal to about 99 mol %, based on 100 mol % of the metal in the lithium transition metal composite oxide excluding lithium. The high-nickel-based positive electrode active material may be capable of providing high capacity and can be used in a high-capacity, high-density rechargeable lithium battery.

The second electrode 112 may function as a negative electrode, in which case the second substrate may be a negative electrode substrate. The negative electrode substrate may be formed of, for example, copper foil or nickel foil, and the negative electrode active material may include, for example, graphite.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si—Q alloy, or a combination thereof. In the formula Si—Q, Q is selected from an alkali metal, an alkaline-earth metal, a Group 13 element, a Group 14 element (excluding Si), a Group 15 element, a Group 16 element, a transition metal, a rare earth element, and a combination thereof. The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in the form of silicon particles and amorphous carbon coated on the surface of the silicon particles. For example, the silicon-carbon composite may include secondary particles (core) in which primary silicon particles are assembled, and an amorphous carbon coating layer (shell) on the surfaces of the secondary particles. The amorphous carbon may also be between the primary silicon particles, and, for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The separator 120 may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON®, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof. But the present disclosure is not limited thereto.

The organic material and the inorganic material may be mixed in one coating layer. In other embodiments, a coating layer including an organic material and a coating layer including an inorganic material may be stacked.

The first electrode tab 201 may protrude from the electrode assembly 100 in a first direction D1. Herein, the upper surface of the electrode assembly 100 may indicate a surface where the electrode tab 200 protrudes from the electrode assembly 100.

The first electrode tab 201 may protrude from the upper surface of the electrode assembly 100. The first electrode tab 201 form a passage for current flow between the first electrode 111 and a first current collector. The first electrode tab 201 may be pre-cut to protrude to one side during the fabrication of the first electrode 111, or the first electrode 111 may further protrude to one side than the separator 120 without additional cutting.

The first electrode tab 201 may be connected to a first electrode terminal 305. The first electrode 111 may be electrically connected to the first electrode terminal 305 through the first electrode tab 201.

The second electrode tab 202 may protrude from the electrode assembly 100 in the first direction D1. The second electrode tab 202 may protrude from the upper surface of the electrode assembly 100. The second electrode tab 202 form a passage for current flow between the second electrode 112 and a second current collector. The second electrode tab 202 may be pre-cut to protrude to one side during the fabrication of the second electrode 112, or the second electrode tab 202 may further protrude to one side than the separator 120 without additional cutting.

The second electrode tab 202 may be connected to a second electrode terminal 304. In particular, the second electrode 112 may be electrically connected to the second electrode terminal 304 by the second electrode tab 202. The position where the first electrode tab 201 protrudes from the electrode assembly 100 may be different from the position where the second electrode tab 202 protrudes from the electrode assembly 100. For example, the first electrode tab 201 may protrude from the upper surface of the electrode assembly 100, and the second electrode tab 202 may protrude from the lower surface of the electrode assembly 100.

The case 300 may include an open side (e.g., one side in a D3 direction of the case 300) to accommodate the electrode assembly 100. The electrode tab 200 may be coupled to a side of the case 300. The side of the case 300 coupled to the electrode tab 200 may refer to one inner side in the D1 direction of the case 300.

The case 300 may have an open side with an opening 301, and an accommodating space 302 that accommodates the electrode assembly 100. The electrode assembly 100 may be inserted through the open side of the case 300 to be accommodated in the accommodating space 302. Then the cover 400 may be coupled to the open side of the case 300 to seal the accommodating space 302.

The case 300 may include an electrolyte injection port 303. The electrolyte injection port 303 may be a through hole formed in a side surface of the case 300. The electrolyte injection port 303 may allow an electrolyte to be injected into the inside of the case 300 of the secondary battery 10 after the case 300 and the cover 400 are bonded and sealed. The electrolyte injection port 303 may be sealed by a sealing member after the electrolyte is injected. In the embodiment depicted in FIG. 1, the electrolyte injection port 303 is positioned on the side 301 of the case 300. But the present disclosure is not limited to such a position, and the position of the electrolyte injection port 303 many vary.

The accommodating space 302 for accommodating the electrode assembly 100 may be formed by a press processing at the center. A flange 320 may be formed at the upper edge of the accommodating space 302 in four directions.

The cover 400 may be coupled to the case 300 to seal the electrode assembly 100 in the case 300. The case 300 may be bonded to the cover 400 to form the exterior of the secondary battery 10. The cover 400 may be formed as a flat plate disposed on the upper part of the case 300 to seal the accommodating space 302. The cover 400 may be large enough to cover the flange 320 and be in contact with the flange 320.

The case 300 and the cover 400 may be metal-bonded (e.g., welding, brazing, soldering, etc.). The flange 320 of the case 300 may be bonded to the edge of the cover 400. After the case 300 is bonded to the cover 400, at least part of the flange 320 may be cut by using laser to increase the energy density of the secondary battery 10.

At least one of the case 300 and the cover 400 may be formed from stainless steel (SUS). For example, the case 300 and the cover 400 illustrated in FIG. 1 may include stainless steel (SUS), and the secondary battery 10 may be a SUS can-type secondary battery. But the present disclosure is not limited to these examples. For example, the case 300 and the cover 400 may be formed of a conductive metal such as aluminum, an aluminum alloy, or nickel-plated steel to form the exterior of the secondary battery 10.

The case 300 and the cover 400 may be formed of the same metallic material. By forming the case 300 and the cover 400 from the same material, corrosion due to a potential difference between different meta may be prevented from occurring at the area where the case 300 and the cover 400 are bonded. The metallic material constituting the case 300 and the cover 400 may include stainless steel (stainless use steel, SUS). The particular type of stainless steel material may be, for example, SUS 304, SUS 316, SUS 420, or SUS 430 depending on the type and ratio of the alloy material within the stainless steel series.

The secondary battery 10 may be a lithium battery cell, a sodium battery cell, etc. However, the scope of the present disclosure is not limited thereto, and the secondary battery 10 be all types of batteries that provide electricity by repeatedly charging and discharging.

The configuration of the secondary battery 10 illustrated in FIG. 1 is only exemplary, and components may be added or omitted. In some embodiments, the shape, the position relationship, etc. of components of the secondary battery 10 illustrated in FIG. 1 may be changed.

D1, D2, and D3 shown in FIG. 1 may indicate the length direction, the width direction, and the thickness direction, respectively, of the secondary battery 10 or the component (e.g., the case 300, the electrode assembly 100, etc.) of the secondary battery 10. For example, the length direction of the case 300 may refer to D1 direction of FIG. 1. The width direction of the case 300 may refer to D2 direction of FIG. 1.

The insulating member 500 may be disposed on the surface of the electrode tab 200 coupled to a side of the case 300, and may be disposed between the electrode assembly 100 and the bent electrode tab 200 when the electrode assembly 100 is accommodated in the case 300.

As shown in FIG. 4, the electrode tab 200 may include a first end portion 210 and a second end portion 220. The first end portion 210 may be coupled to a side of the case 300. The first end portion 210 may be a portion of the electrode tab 200 that is spaced from the upper surface of the electrode assembly 100. The first end portion 210 may be electrically connected to the first electrode terminal 305 disposed in the case 300.

The second end portion 220 may extend from the first end portion 210 to the electrode assembly 100. For example, the second end portion 220 may extend from the first end portion 210 to the upper surface of the electrode assembly 100. The second end portion 220 may be bent at least once and accommodated inside the case 300. And the second end portion 220 may be electrically connected to the first electrode terminal 305 through the first end portion 210.

As shown in FIG. 4, the insulating member 500 may include a first insulating member 501 and a second insulating member 502. The first insulating member 501 may be disposed on a surface of the first end portion 210, with the first insulating member 501 being bonded to the surface of the first end portion 210. When the first end portion 210 is coupled to the inner side of the case 300, the first insulating member 501 may be in contact with the surface of the first end portion 210. The first insulating member 501 may insulate between the electrode tab 200 and the case 300.

The second insulating member 502 may be disposed between the surface of the second end portion 220 adjacent to the electrode assembly 100 and the electrode assembly 100. The second insulating member 502 may be bonded to the surface of the second end portion 220. When the second end portion 220 is bent inside the case 300, the second insulating member 502 may contact the surface of the second end portion 220 adjacent to the electrode assembly 100. Thus, the second insulating member 502 may insulate between the electrode tab 200 and the electrode assembly 100.

The electrode tab 200 may include the first electrode tab 201 connected to the first electrode 111. The electrode tab 200 may also include a second electrode tab 202 spaced apart from the first electrode tab 201 and protruding from a surface of the electrode assembly 100. The insulating member 500 may be formed of a thin film or a plate shape that is an insulating material.

The insulating member 500 may be formed to extend in the width direction (D2 direction) of the case 300 to cover at least part of the first electrode tab 201 and the second electrode tab 202. In another embodiment, the insulating member 500 may be formed to extend in the width direction (D2 direction) of the case 300. The insulating member 500 may allow the first electrode tab 201 and the second electrode tab 202 to be insulated from areas in contact with the case 300 and the cover 400, and the insulating member 500 may allow the first electrode tab 201 and the second electrode tab 202 to be insulated from areas in contact with the upper surface of the electrode assembly 100. The insulating member 500 may extend in the width direction (D2 direction) of the case 300 to cover at least part of the first electrode tab 201 and the second electrode tab 202 to prevent short-circuits of the electrode assembly 100 or the case 300 even though the first electrode tab 201 and the second electrode tab 202 are moved or bent.

When the bent electrode tab 200 and the insulating member 500 are disposed between the inner side of the case 300 and the upper surface of the electrode assembly 100, the electrode assembly 100 may be accommodated in the case 300 with the inner side of the case 300 and the upper surface of the electrode assembly 100 face each other.

Referring to FIG. 3, in a secondary battery according to a comparative example, an electrode tab 4 of an electrode assembly 1 may be connected to an electrode terminal 5 in a case 2. The electrode assembly 1 may be accommodated in the case 2, and the case 2 may be sealed by a cover 3. An insulating case 6 may be provided inside the case 2 to prevent short-circuits between the electrode tab 4 and the case 2. But the internal space of the case 2 where the insulating case 6 is disposed forms a dead volume V1 of the secondary battery, which reduces the energy density of the secondary battery.

The insulting member 500 may prevent the short-circuit between the electrode tab 200 and the case 300 without the need for an insulating case in the case 300. For example, when the first end portion 210 is in contact with a side of the case 300, the first insulating member 501 may be bonded to a surface of the first end portion 210. The first insulating member 501 and the bent surface of the second end portion 220 may be in contact with each other without additional space being formed. The second insulating member 502 need not be placed between the bent second end portion 220 and the upper surface of the electrode assembly 100. Therefore, without the space for accommodating the insulating case, a short-circuit in the secondary battery may be prevented and the dead volume may be reduced. And the accommodation space 302 of the electrode assembly 100 may increase by the size of the otherwise required dead volume, thereby increasing the energy density of the secondary battery 10.

Only a minimum space may be required for bending the electrode tab, which may minimize the portion of the internal space of the secondary battery that does not contribute to the battery capacity. When the bent electrode tab 200 and the insulating member 500 are placed between the inner side of the case 300 and the upper surface of the electrode assembly 100, the electrode assembly 100 may be accommodated in the case 300 so that the inner surface of the case 300 faces the upper surface of the electrode assembly 100.

The minimized space between the electrode assembly 100 and the inner side of the case 300 may prevent the movement of the electrode assembly 100 in the length direction of the case 300. Therefore, the deformation due to the movement of the electrode assembly 100 by dropping, etc. may be prevented, and the ignition accidents by short-circuits may be prevented. Thus, the secondary battery 10 is made safer.

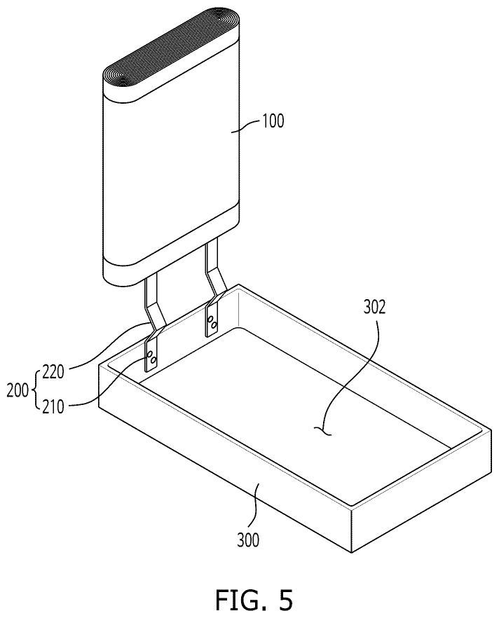

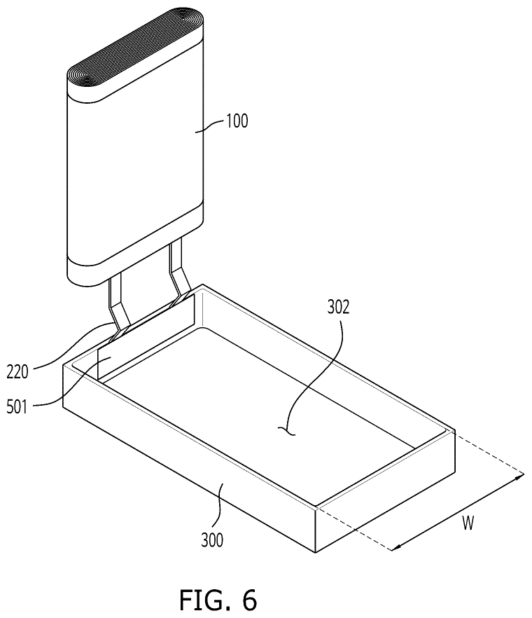

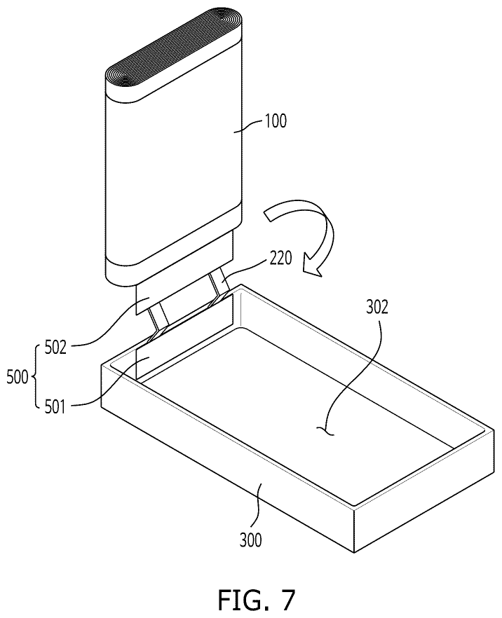

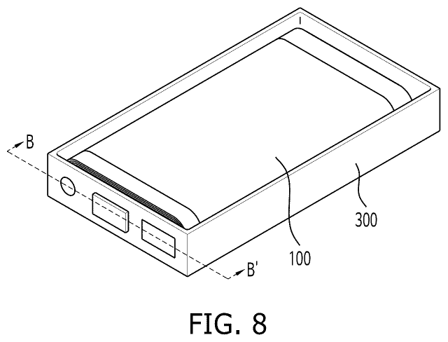

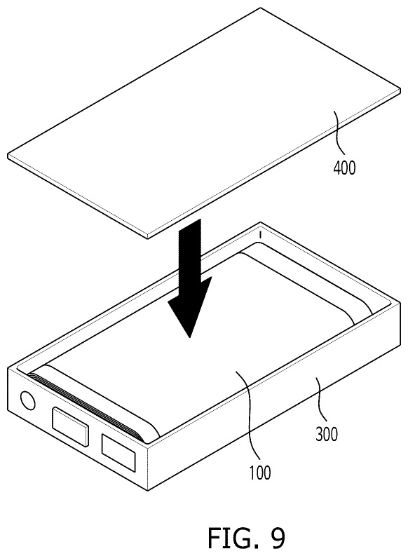

FIG. 5 is a view of a state where an electrode tab of a secondary battery is bonded to a side of a case, FIG. 6 is a view of a state where an insulating member is added to a first end portion of FIG. 5, FIG. 7 is a view of a state where an insulating member is added to a second end portion of FIG. 6, FIG. 8 is a view of a state where an electrode assembly in FIG. 7 is accommodated in a case, and FIG. 9 is a view showing a cover is bonded to a case of FIG. 8.

The electrode tab 200 protruding outwardly from the electrode assembly 100 may be coupled to the inner side of the case 300. For example, the first end portion 210 may be welded to a side of the case 300. The second end portion 220 may be unbent before the electrode assembly 100 is accommodated in the accommodating space 302. Then, the second end portion 220 may be bent when the electrode assembly 100 is accommodated in the accommodating space 302. Referring to FIGS. 5 to 7, the second end portion 220 is illustrated as being bent once, but it may be bent several times as needed.

When the first end portion 210 is coupled to a side of the case 300, a first insulating member 501 may be disposed on a surface of the first end portion 210. For example, the first insulating member 501 may be bonded to the surface of the first end portion 210. The first insulating member 501 may be provided to extend to cover at least part of the electrode tab 200 in a width W direction of the case 300. In some embodiments, the first insulating member 501 may extend to cover all of the inner surface of the case 300 in the width W direction of the case 300.

The insulating member 500 may include the first insulating member 501 and the second insulating member 502. When the first insulating member 501 is bonded to one surface of the first end portion 210, the second insulating member 502 may be coupled to a surface of the second end portion 220 adjacent to the electrode assembly 100. Thus,, when the electrode assembly 100 is accommodated in the case 300, the insulating members 501 and 502 may be positioned in the area where insulating is required between the electrode assembly 100, the case 300, and/or the electrode tab 200, which thereby prevents short-circuits in the secondary battery 10.

When the first insulating member 501 and the second insulating member 502 are positioned, the electrode assembly 100 may be rotated in the direction of the arrow of FIG. 7 to be accommodated inside the case 300. That is, the electrode assembly 100 may rotate along a predetermined trajectory to be accommodated in the case 300. As shown in FIG. 9, when the electrode assembly 100 is accommodated in the case 300, the cover 400 may be coupled to the case 300. The cover 400 may be coupled to the case 300 to seal the electrode assembly 100 from outside. For example, the cover 400 may be welded along the periphery of a surface of the case 300, but the present disclosure is not limited thereto.

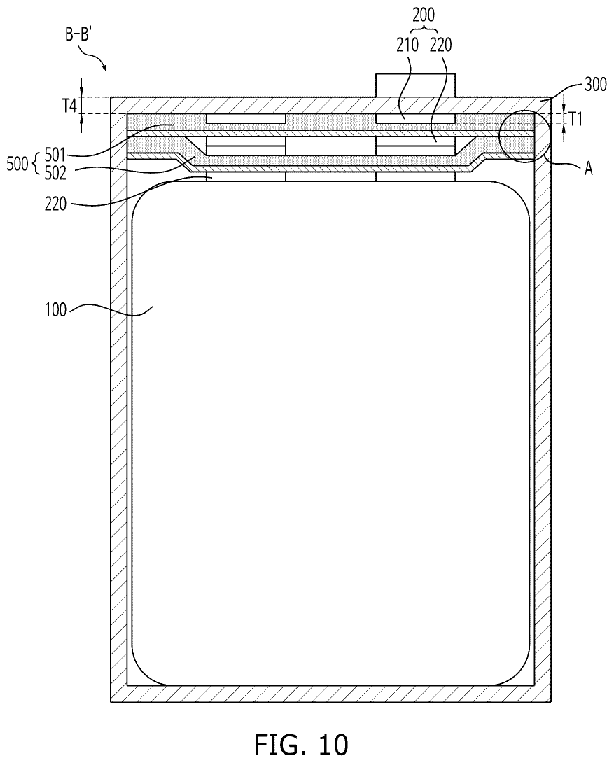

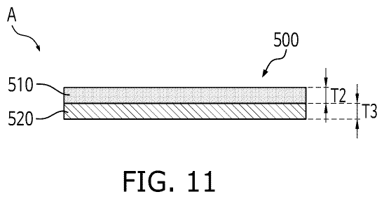

FIG. 10 is a cross-sectional view taken along line B-B′ of FIG. 8, and FIG. 11 is an enlarged view of area A of FIG. 10.

The insulating member 500 may include an adhesive layer 510 and an insulating layer 520. The adhesive layer 510 may be coupled to a surface of the electrode tab 200. The insulating layer 520 may be positioned on a surface of the adhesive layer 510. The adhesive layer 510 may be formed of a material having adhesion.

The insulating layer 520 may be formed of an insulating material to prevent short-circuits in the secondary battery. For example, the insulating layer 520 may include at least one of polyethylene terephthalate (PET), polypropylene (PP), and polyether ether ketone (PEEK). But the present disclosure is not limited to these examples.

The first insulating member 501 and the second insulating member 502 may be formed of a thin film and a plate shape. While the first end portion 210 is coupled to the inner side of the case 300, the first insulating member 501 may be bonded to a surface of the first end portion 210 and the inner side of the case 300. Therefore, the first end portion 210 may be more stably fixed to the inner side of the case 300.

When the second end portion 220 is bent, the second insulating member 502 may be bonded to a surface of the second end portion 220 adjacent to the electrode assembly 100 and the first insulating member 501. Therefore, the second end portion 220 may more stably maintain its bent state.

In specific examples, the thickness of the case 300 or cover may be 50 μm to 100 μm. A thickness T2 of the adhesive layer 510 may be 20 μm to 40 μm thicker than a thickness T1 of the electrode tab 200. A thickness T3 of the insulating layer 520 may be formed to be 180% to 220% of the thickness T2 of the adhesive layer 510. The adhesive layer 510 may be 20 μm to 40 μm thicker than the thickness T1 of the electrode tab 200, thereby preventing the movement of the electrode assembly 100 between the upper surface of the electrode assembly 100 and the inner surface of the case 300. The insulating layer 520 may have a thickness ranging from 180% to 220% of the adhesive layer 510 to maintain insulating.

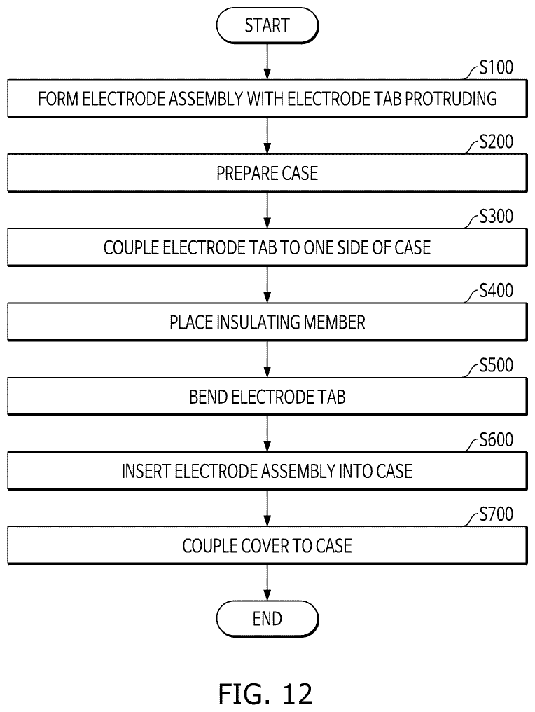

FIG. 12 is a flowchart of a method of manufacturing a secondary battery according to embodiments of the present disclosure.

According to embodiments, a method of manufacturing a secondary battery may include forming an electrode assembly with an electrode tab protruding in step S100, preparing a case in step S200, bonding an electrode tab to one side of a case in step S300, placing an insulating member in step S400, bending an electrode tab in step S500, inserting an electrode assembly into a case in step S600, and coupling a cover into a case in step S700.

The forming of the electrode assembly in step S100 may include configuring an electrode assembly to provide an electrode tab connected to an electrode and outwardly protruding. The forming of the electrode assembly in step S100 may include forming an electrode assembly including a first electrode, a second electrode and a separator disposed between the first electrode and the second electrode.

After the electrode assembly is formed in step S100, the preparing of the case may be performed in step S200. The preparing of the case in step S100 may include preparing a case with an opening.

After the preparing of the case 200, an electrode tab may be coupled to a side of a case in step S300. The electrode tab may include a first end portion coupled to a side of the case and a second end portion extending from the first end portion to the electrode assembly, with the electrode tab being bent at least once to be accommodated inside the case. The coupling of the electrode tab in step S300 may include coupling the first end portion to an inner side of the case by welding.

After the coupling of the electrode tab in step S300, an insulating member may be placed in step S400. Placing an insulating member in step S400 may include placing an insulating member on a surface of an electrode tab coupled to the side of the case and the surface of an electrode tab adjacent to an electrode assembly.

For example, placing an insulating member in step S400 may include placing a first insulating member on the surface of a first end portion and placing a second insulating member on the surface of a second end portion adjacent to the electrode assembly. The insulating member may include an adhesive layer coupled to the surface of an electrode tab and an insulating layer provided on a surface of the adhesive layer.

Arranging the insulating member in step S400 may include bonding an adhesive layer to the surface of the electrode tab coupled to the side of the case. The insulating layer may include, for example, at least one of polyethylene terephthalate (PET), polypropylene (PP), and polyether ether ketone (PEEK).

After the insulating member is placed in step S400, the electrode tab may be bent in step S500. In another embodiment, the electrode tab may be bent in step S500 before the insulating member is placed in step S400.

Bending the electrode tab in step S500 may include bending the electrode tab at least once. For example, the electrode tab may be bent in step S500 bent so that a first insulating member and a second insulating member face each other with an electrode tab interposed therebetween.

Inserting an electrode assembly into a case in step S600 may be inserting an electrode assembly through an opening in the case. For example, inserting an electrode assembly in step 600 may include placing an electrode assembly so that an inner side of the case and the upper surface of the electrode assembly face each other when the bent electrode tab and the insulating member are placed between the inner side of the case and the upper surface of the electrode assembly.

After the inserting of the electrode assembly in step S600, a cover may be coupled to the case in step S700. The coupling of the cover to the case seals an electrode assembly in the case from the outside. More specifically, the cover covers an opening in the case. The cover may be welded along the periphery of side of the case in which the opening is formed, but the present disclosure is not limited thereto.

The flow chart of FIG. 12 and the above description are merely exemplary, and the scope of the present disclosure is not limited thereto. For example, one or more steps in the flow chart and the above description may be deleted, the orders of one or more steps may be changed, one or more steps may be performed simultaneously, or one or more steps may be performed repeatedly multiple times.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

### Description of Notations

10: Secondary Battery
100: Electrode Assembly
200: Electrode Tab
210: First End Portion
220: Second End Portion
300: Case
400: Cover
500: Insulating Member
501: First Insulating Member
502: Second Insulating Member
510: Adhesive Layer
520: Insulating Layer

What is claimed is:

1. A secondary battery comprising:
a case in which an opening is formed;
an electrode assembly accommodated in the case, the electrode assembly including an electrode;
an electrode tab connected to the electrode and protruding outwardly from the electrode assembly, the electrode tab being coupled to a side of the case;
a cover covering the opening in the case and sealing the electrode assembly from outside of the case; and
an insulating member placed on a surface of the electrode tab coupled to the side of the case, the insulating member being positioned between the electrode assembly and the electrode tab.

2. The secondary battery as claimed in claim 1, wherein the electrode tab comprises:
a first end portion coupled to the side of the case; and
a second end portion extending from the first end portion to the electrode assembly, the second end portion being bent at least once inside the case.

3. The secondary battery as claimed in claim 2, wherein the insulating member comprises:
a first insulating member disposed on a surface of the first end portion; and
a second insulating member between a surface of the second end portion adjacent to the electrode assembly and the electrode assembly.

4. The secondary battery as claimed in claim 1, wherein the insulating member comprises:
an adhesive layer coupled to a surface of the electrode tab; and
an insulating layer provided on a surface of the adhesive layer.

5. The secondary battery as claimed in claim 4, wherein the insulating layer includes at least one of polyethylene terephthalate, polypropylene, and polyether ether ketone.

6. The secondary battery as claimed in claim 4, wherein the adhesive layer has a thickness of 20 μm to 40 μm greater than a thickness of the electrode tab.

7. The secondary battery as claimed in claim 4, wherein the insulating layer has a thickness of 180% to 220% of a thickness of the adhesive layer.

8. The secondary battery as claimed in claim 1, wherein the case and the cover are formed of a same metal material.

9. The secondary battery as claimed in claim 8, wherein the metal material includes stainless use steel.

10. The secondary battery as claimed in claim 1, wherein a thickness of the case or the cover is 50 μm to 100 μm.

11. The secondary battery as claimed in claim 1, wherein the electrode includes a first electrode and a second electrode,
wherein the electrode tab comprises:
a first electrode tab connected to the first electrode; and
a second electrode tab connected to the second electrode, the second electrode tab spaced apart from the first electrode tab and protruding from a surface of the electrode assembly, and
wherein the insulating member extends in a width direction of the case to cover at least part of the first electrode tab and at least a part of the second electrode tab.

12. The secondary battery as claimed in claim 1, wherein the electrode assembly is accommodated in the case such that an inner side of the case and an upper surface of the electrode assembly to face each other, with the insulating member being disposed between the inner side of the case and the upper surface of the electrode assembly.

13. A method for manufacturing a secondary battery, the method comprising:
forming an electrode assembly with an electrode tab connected to an electrode and protruding outwardly;
preparing a case with an opening;
attaching the electrode tab to a side of the case;
arranging an insulating member on the electrode tab coupled to the side of the case and on electrode tab adjacent to the electrode assembly;
bending the electrode tab at least once;
inserting the electrode assembly into the case; and
attaching a cover to the opening in the case to seal the electrode assembly from outside.

14. The method as claimed in claim 13, wherein the electrode tab comprises:
a first end portion attached to the side of the case; and
a second end portion extending from the first end portion to the electrode assembly and bent at least one to be accommodated inside the case.

15. The method as claimed in claim 14, wherein the arranging of the insulating member comprises:
arranging a first insulating member on a surface of the first end portion; and
arranging a second insulating member on a surface of the second end portion adjacent to the electrode assembly.

16. The method as claimed in claim 14, wherein the attaching of the electrode tab comprises welding the first end portion to an inner side of the case.

17. The method as claimed in claim 13, wherein the insulating member comprises:
an adhesive layer attached to a surface of the electrode tab; and
an insulating layer provided on a surface of the adhesive layer.

18. The method as claimed in claim 17, wherein the arranging of the insulating member comprises attaching the adhesive layer to the electrode tab coupled to the side of the case.

19. The method as claimed in claim 17, wherein the insulating layer comprises at least one of polyethylene terephthalate, polypropylene, and polyether ether ketone.

20. The method as claimed in claim 13, wherein the inserting of the electrode assembly comprises, in response to the bent electrode tab and the insulating member being disposed between an inner side of the case and an upper side of the electrode assembly, arranging the electrode assembly with the inner side of the case and the upper side of the electrode assembly facing each other.
